(19) United States
(12) Patent Application Publication
(10) Pub. No.: US 2008/0133801 A1
(43) Pub. Date: Jun. 5, 2008

(54) KEYBOARD-VIDEO-MOUSE SWITCH SYSTEM FOR SWITCHING BETWEEN COMPUTERS HAVING A PLURALITY OF VIDEO SOURCES EACH AND SWITCHING METHOD THEREOF

(75) Inventors: Chih-tao Hsieh, Shijr City (TW); Wei-min Huang, Shijr City (TW); Chieh-wei Lin, Shijr City (TW)

Correspondence Address: MADSON & AUSTIN, 15 WEST SOUTH TEMPLE, SUITE 900, SALT LAKE CITY, UT, 84101, US

(73) Assignee: Aten International Co., Ltd., Shijr City (TW)

(21) Appl. No.: 11/566,319

(22) Filed: Dec. 4, 2006

(51) Int. Cl. G06F 13/38

(52) U.S. Cl. 710/62

(57) ABSTRACT

A KVM switch system and switching method are described. The KVM switch system for switching between a first computer and a second computer includes a first KVM switch, a second KVM switch and the synchronization cable. The first computer provides a first video source and a second video source. The second computer provides a third video source and a fourth video source. The synchronization cable couples the first KVM switch to the second KVM switch and transmits a control signal. In the beginning, the first KVM switch is coupled to the first video source and the second KVM switch is coupled to the second video source. When the first KVM switch is switched from the first video source to the third video source of the second computer, the first KVM switch controls the second KVM switch to select the fourth video source of the second computer by the control signal transmitted on the synchronization cable.

### FIELD OF THE INVENTION

The present invention generally relates to a keyboard-video-mouse (KVM) switch system and method for performing the switching function thereof, and more particularly to a KVM switch system for switching a plurality of computers having a plurality of video sources each and switching method thereof.

### BACKGROUND OF THE INVENTION

Please refer to FIG. 1 which depicts a schematic diagram of a conventional KVM switch system 100. The KVM switch system 100 for switching a first computer 102 and a second computer 104 includes a first KVM switch 106, a second KVM switch 108. The first computer 102 has a first video source 110a and a second video source 110b and the second computer 104 has a third video source 110c and a fourth video source 110d.

Each of the first KVM switch 106 and the second KVM 108 is connected to a respective console station, including a keyboard 112, a mouse 114, and a video display 116. Traditionally, the first KVM switch 106 is directly connected to the first video source 110a and the second video source 110b of the first computer 102 via the first video port 120a. The second KVM switch 108 is directly connected to the third video source 110c and the fourth video source 110d of the second computer 104 via the second video port 120b. The KVM switch system 100 allows users to operate one of the plurality of computers by employing the keyboard 112 and the mouse 114.

However, conventionally, it is necessary to manually press the first switch button 118 of the first KVM switch 106 first and then the second switch button 120 of the second KVM switch 108 in order to implement the switch operations of the video sources of the computers, respectively. Such a situation is inconvenient and slow since two switch steps are required by pressing the first switch button 118 and the second switch button 120, thus resulting in time-consuming and inefficient switch operation. Moreover, because each of the KVM switches must be equipped with a set of console station, including a keyboard and a mouse, there is no cost-effectiveness. Consequently, there is a need to develop a KVM switch system to solve the above-mentioned problems.

### SUMMARY OF THE INVENTION

One object of the present invention is to provide a KVM switch system and switching method for switching the video source of the computers rapidly and conveniently.

Another object of the present invention is to provide a KVM switch system and switching method for switching the video source of the computers by a single console to improve the cost-effectiveness of the KVM switch system.

In the first embodiment, the KVM switch system enables a first KVM switch and a second KVM switch to switch between a first computer and a second computer synchronously via a synchronization cable. The first computer provides a first video source and a second video source. The second computer provides a third video source and a fourth video source. The synchronization cable transmits a control signal.

The first KVM switch includes a first video port, a second video port, a switch button and at least one of a keyboard port and a mouse port. The first KVM switch performs switch operation between the first video source of the first computer and the third video source of the second computer. The first video port is coupled to the first video source and the second video port is coupled to the third video source. The second KVM switch includes a third video port and a fourth video port, each of which can be coupled to the second video source of the first computer and the fourth video source of the second computer, respectively. The second KVM switch implements the switch operation between the second video source and the fourth video source. The synchronization cable couples the first KVM switch to the second KVM switch. While transmitting the control signal, the synchronization cable synchronizes the switch operation of the first KVM switch and the second KVM switch.

In the second embodiment, the KVM switch system enables a first KVM switch, a second KVM switch and a third KVM switch to switch among a first computer, a second computer and a third computer synchronously via a first synchronization cable and a second synchronization cable. The first computer provides a first video source, a second video source and a third video source, the second computer provides a fourth video source, a fifth video source and a sixth video source, and the third computer provides a seventh video source, an eighth video source and a ninth video source.

The first KVM switch includes a first video port, a second video port, a third video port, a switch button and at least one of a keyboard port and a mouse port. The first KVM switch performs switch operation among the first video source, the fourth video source and the seventh video source. The first video port, the second video port, the third video port are coupled to the first video source, the fourth video source and the seventh video source. The second KVM switch includes fourth video port, the fifth video port, the sixth video port, each of which is coupled to the second video source, the fifth video source and the eighth video source, respectively. The second KVM switch implements the switch operation among the second video source, the fifth video source and the eighth video source. Likewise, the third KVM switch includes a seventh video port, a eighth video port and the ninth video port, each of which is coupled to the third video source, the sixth video source and the ninth video source. The third KVM switch implements the switch operation among the third video source, the sixth video source and the ninth video source. The first synchronization cable couples the first KVM switch to the second KVM switch, and the second synchronization cable couples the second KVM switch to the third KVM switch. While transmitting the control signal, the first synchronization cable and the second synchronization cable synchronizes the switch operation of the first KVM switch, the second KVM switch and the third KVM switch.

The control signal from the first KVM switch also assigns a first identification number and a second identification number to the second KVM switch and the third KVM switch, respectively. When the first KVM switch is switched from the first video source to the fourth video source, the first KVM switch controls the second KVM switch to select the fifth video source in response to the first identification number. Meanwhile, the second KVM switch ignores the first identification number of the control signal. The first KVM switch controls the third KVM switch to select the sixth video source of the second computer in response to the second identification number corresponding to the third KVM switch, and meantime the third KVM switch ignores the second identification number of the control signal. When the first KVM switch is switched from the first video source or the fourth video source to the seventh video source, the first KVM switch controls the second KVM switch to select the eighth video source in response to the first identification number corresponding to the second KVM switch. Meanwhile, the second KVM switch ignores the first identification number of the control signal. The first KVM switch controls the third KVM switch to select the ninth video source of the third computer in response to the second identification number corresponding to the third KVM switch, and the third KVM switch ignores the second identification number of the control signal.

In the third embodiment, the KVM switch system is similar to the KVM switch system depicted in the second embodiment except the connection among the first KVM switch, the second KVM switch and the third KVM switch.

In operation, first, the first KVM switch generates a control signal when the first KVM switch is switched from a first video source of a first computer to a third video source of a second computer. Afterwards, the control signal of the first KVM switch is transmitted to the second KVM switch via the synchronization cable. Finally, the second KVM switch is controlled by the first KVM switch to select from the second video source of the first computer to the fourth video source of the second computer, without manual operation, in response to the control signal.

Since the synchronization cable couples the first KVM switch to the second KVM switch and the third KVM switch, respectively, and transmits the control signal to the second KVM switch and the third KVM switch, the first KVM switch can dominate the switch operation of the second KVM switch and/or the third KVM switch. Thus, the first KVM switch and the second KVM switch allow a user to concurrently perform the switch operation at a single time for displaying the images from the video sources on the display devices.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a conventional KVM switch system;

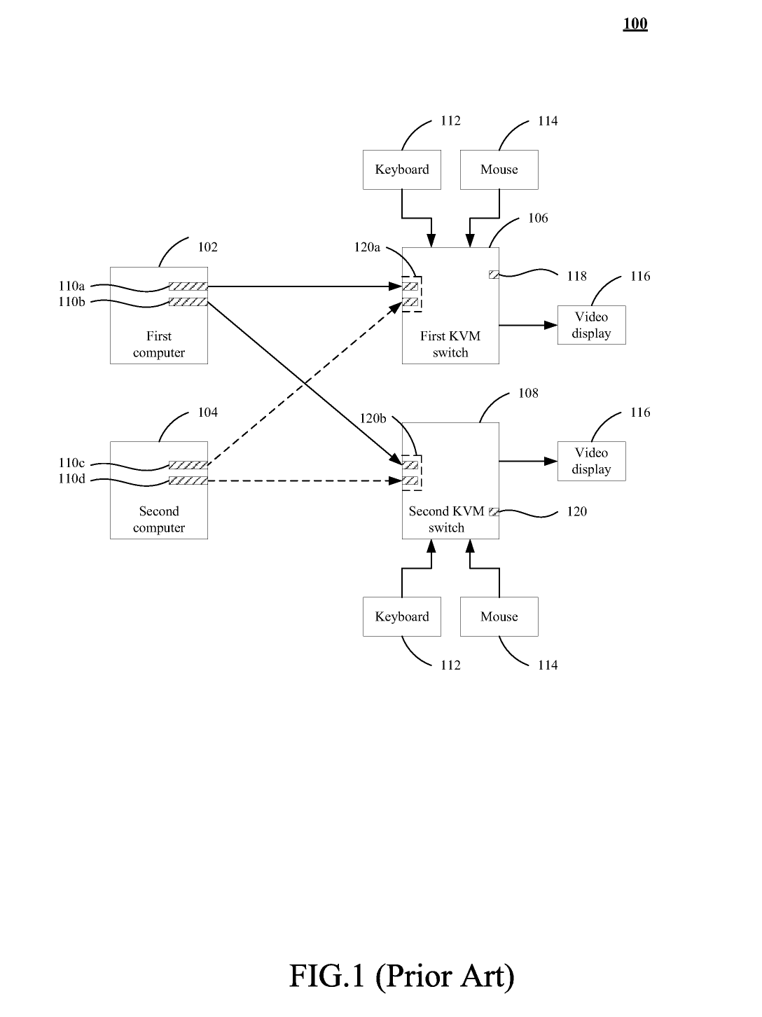

FIG. 2 is a schematic diagram of a KVM switch system having a synchronizing cable according to the first embodiment of the present invention;

FIG. 3 is a schematic diagram of a KVM switch system having a synchronizing cable according to the second embodiment of the present invention;

FIG. 4 is a schematic diagram of a KVM switch system having a synchronizing cable according to the third embodiment of the present invention; and

FIG. 5 is a flow chart of performing the KVM switch system according to one embodiment of the present invention.

### DETAILED DESCRIPTION OF THE PREFERRED EMBODIMENTS

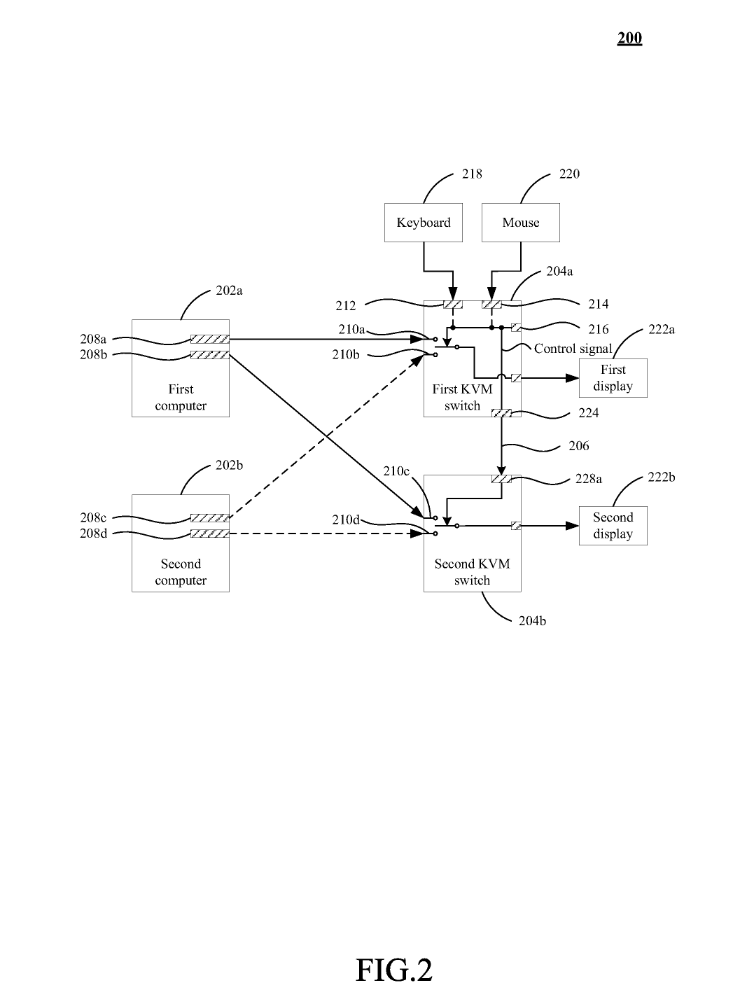

Please refer to FIG. 2 which depicts a schematic diagram of a KVM switch system 200 having a synchronization cable 206 according to the first embodiment of the present invention. The KVM switch system 200 enables a first KVM switch 204a and a second KVM switch 204b to switch between a first computer 202a and a second computer 202b synchronously via the synchronization cable 206. The first computer 202a provides a first video source 208a and a second video source 208b. In one embodiment, the first video source 208a and the second video source 208b can be video cards installed on the first computer 202a. The second computer 202b provides a third video source 208c and a fourth video source 208d. In one embodiment, the third video source 208c and the fourth video source 208d can be video cards installed on the second computer 202b. A keyboard 218 and a mouse 220 are connected to the first KVM switch 204a. A first display 222a and a second display 222b are coupled to the first computer 202a and the second computer 202b via the first KVM switch 204a and the second KVM switch 204b, respectively, for selectively displaying the images from the video sources (208a through 208d).

The first KVM switch 204a includes a first video port 210a, a second video port 210b, a switch button 216 and at least one of a keyboard port 212 and a mouse port 214. The first KVM switch 204a performs switch operation between the first video source 208a of the first computer 202a and the third video source 208c of the second computer 202b. At first, the first video port 210a is coupled to the first video source 208a and the second video port 210b is coupled to the third video source 208c. The second KVM switch 204b includes a third video port 210c and a fourth video port 210d, each of which can be coupled to the second video source 208b of the first computer 202a and the fourth video source 208d of the second computer 202b, respectively. The second KVM switch 204b implements the switch operation between the second video source 208b and the fourth video source 208d.

The synchronization cable 206 couples the first KVM switch 204a to the second KVM switch 204b and transmits a control signal. Via the control signal, the synchronization cable 206 synchronizes the switch operation of the first KVM switch 204a and the second KVM switch 204b. That is, when the first KVM switch 204a is switched from the first video source 208a to the third video source 208c of the second computer 202b, the first KVM switch 204a controls the second KVM switch 204b to select the fourth video source 208d of the second computer 202b in response to the control signal transmitted by the synchronization cable 206. In one embodiment, when the first KVM switch 204a receives a request from the keyboard port 212 or the mouse port 214, or receives a hokey signal of the keyboard 218, the first KVM switch 204a generates the control signal. Alternatively, the first KVM switch 204a generates the control signal when the switch button 216 is pressed. Further, the synchronization cable 206 can be a pair of conducting wires for transmitting the control signal. Preferably, the synchronization cable 206 is a cable of transmitting an audio signal, which is used to transmit the control signal in the present invention.

Additionally, the first KVM switch 204a, serving as a master, further includes a first control port 224 for outputting the control signal to the second KVM switch 204b. Similarly, the second KVM switch 204b, serving as a slave, further includes a second control port 228a coupling the first control port 224 to the second KVM switch 204b via the synchronization cable 206 such that the second KVM switch 204b can control the switch operation between the second video source 208b and the fourth video source 208d, without manual operation, by the control signal. In one preferred embodiment of the present invention, the first KVM switch 204a or the second KVM switch 204b is a kind of KVM switch having only one set of console port, e.g. the keyboard port 212 or the mouse port 214.

Since the synchronization cable 206 couples the first KVM switch 204a to the second KVM switch 204b and transmits the control signal to the second KVM switch 204b, the first KVM switch 204a can dominate the switch operation of the second KVM switch 204b between the second video source 208b and the fourth video source 208d when the first KVM switch 204a is switched between the first video source 208a and the third video source 208c. Thus, the first KVM switch 204a and the second KVM switch 204b allow a user to concurrently perform the switch operation at a single time for displaying the images from the video sources (208a through 208b) on the first display 222a and the second display 222b rapidly and conveniently.

It should be noted that console devices, including the keyboard 218 and the mouse 220, are selectively connected to one of the first KVM switch 204a or the second KVM switch 204b to simplify the switch operation. In the present invention, the keyboard 218 and the mouse 220 are only connected to the first KVM switch 204a but not connected to the second KVM switch 204b. Similarly, the keyboard 218 and the mouse 220 can be only connected to the second KVM switch 204b but not be connected to the first KVM switch 204a. Additionally, when one of the keyboard 218 and the mouse 220 is connected to the first KVM switch 204a, i.e. only one set of console coupled to the KVM switch (204a or 204b) is utilized, the KVM switch system 200 can advantageously implement the switch action between the first computer 202a and the second computer 202b once. Therefore, the KVM switch system 200 makes an improvement of the cost-effectiveness of the KVM switch.

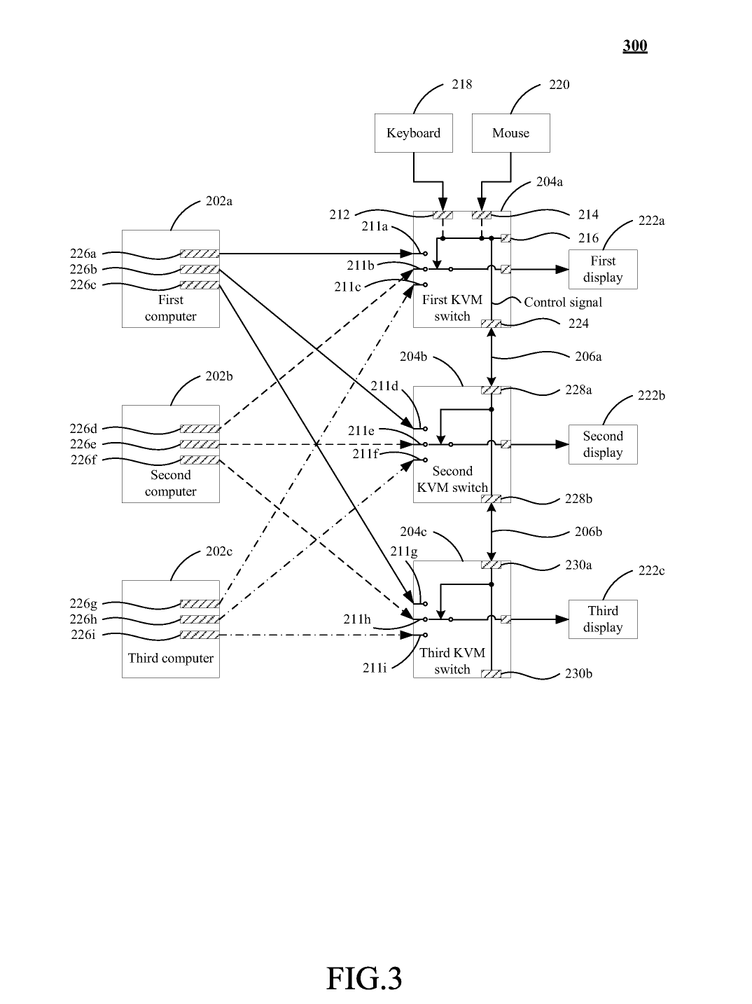

Please refer to FIG. 3 which depicts a schematic diagram of a KVM switch system 300 having a plurality of synchronization cables according to the second embodiment of the present invention. The KVM switch system 300 enables a first KVM switch 204a, a second KVM switch 204b and a third KVM switch 204c to switch among a first computer 202a, a second computer 202b and a third computer 202c synchronously via a first synchronization cable 206a and a second synchronization cable 206b. The first computer 202a provides a first video source 226b, a second video source 226c and a third video source 226a, the second computer 202b provides a fourth video source 226d, a fifth video source 226e and a sixth video source 226f, and the third computer 202c provides a seventh video source 226g, an eighth video source 226h and a ninth video source 226i. A keyboard 218 and a mouse 220 are connected to the first KVM switch 204a. A first display 222a, a second display 222b and a third display 222c are coupled to the first computer 202a, the second computer 202b and the third computer 202c via the first KVM switch 204a, the second KVM switch 204b and the third KVM switch 204c, respectively, for selectively displaying the images from the video sources (226a through 226i).

The first KVM switch 204a includes a first video port 211a, a second video port 211b, a third video port 211c, a switch button 216 and at least one of a keyboard port 212 and a mouse port 214. The first KVM switch 204a performs switch operation among the first video source 226a, the fourth video source 226d and the seventh video source 226g. The first video port 210a, the second video port 211b, the third video port 211c can be coupled to the first video source 226a, the fourth video source 226d or the seventh video source 226g, respectively. The second KVM switch 204b includes the fourth video port 211d, the fifth video port 211e, the sixth video port 211f, each of which can be coupled to the second video source 226b, the fifth video source 226e and the eighth video source 226h, respectively. The second KVM switch 204b implements the switch operation among the second video source 226b, the fifth video source 226e and the eighth video source 226h. Likewise, the third KVM switch 204c includes a seventh video port 211g, a eighth video port 211h and the ninth video port 211i, each of which can be coupled to the third video source 226c, the sixth video source 226f and the ninth video source 226i. The third KVM switch 204c implements the switch operation among the third video source 226c, the sixth video source 226f and the ninth video source 226i.

The first synchronization cable 206a couples the first KVM switch 204a to the second KVM switch 204b, and the second synchronization cable 206b couples the second KVM switch 204b to the third KVM switch 204c. The first synchronization cable 206a and the second synchronization cable 206b transmit a control signal. Via the control signal, the synchronization cable 206a and the second synchronization cable 206b synchronizes the switch operation of the first KVM switch 204a, the second KVM switch 204b and the third KVM switch 204c. In other words, when the first KVM switch 204a is switched, the first KVM switch 204a controls the switch statuses of the second KVM switch 204b and the third KVM switch 204c in response to the control signal transmitted by the first synchronization cable 206a and the second synchronization cable 206b. In one embodiment, the first KVM switch 204a receives a request from the keyboard port 212 or the mouse port 214, or receives a hokey signal of the keyboard 218, the first KVM switch 204a generates the control signal. Alternatively, the switch button 216 generates the control signal when the switch button 216 is pressed. Further, the first synchronization cable 206a or the second synchronization cable 206b can be a pair of conducting wires for transmitting the control signal. Preferably, the first synchronization cable 206a or the second synchronization cable 206b is a cable for transmitting an audio signal originally, which is used to transmit the control signal in the present invention.

In addition, the first KVM switch 204a, serving as a master, includes a first control port 224 for outputting the control signal to the second KVM switch 204b. Similarly, the second KVM switch 204b, serving as a slave, includes a second control port 228a and a third control port 228b. The second control port 228a receives the control signal from the first control port 224 such that the second KVM switch 204b controls the switch operation among the second video source 226b, the fifth video source 226e and the eighth video source 226h and the third control port 228b sends the received control signal to the third KVM switch 204c via the third control port 228b.

The third KVM switch 204c, also serving as a slave, includes a fourth control port 230a and a fifth control port 230b. The fourth control port 230a receives the control signal from the third control port 228b via the synchronization cable 206 such that the third KVM switch 204c controls the switch operation among the third video source 226c, the sixth video source 226f and the ninth video source 226i. In one preferred embodiment of the present invention, the first KVM switch 204a, the second KVM switch 204b or the third KVM switch 204c is a kind of KVM switch having only one set of console port, e.g. the keyboard port 212 or the mouse port 214. It should be noted that the fifth control port 230b allows users to dominate one or more next stages of KVM switches (not shown).

In one embodiment, the control signal from the first KVM switch 204a also assigns a first identification number and a second identification number to the second KVM switch 204b and the third KVM switch 204c, respectively. When the first KVM switch 204a is switched from the first video source 226a to the fourth video source 226d of the second computer 202b, the first KVM switch 204a controls the second KVM switch 204b to select the fifth video source 226e of the second computer 202b in response to the first identification number corresponding to the second KVM switch 204b. Meanwhile, the second KVM switch 204b ignores the first identification number of the control signal. The first KVM switch 204a controls the third KVM switch 204c to select the sixth video source 226f of the second computer 202b in response to the second identification number corresponding to the third KVM switch 204c, and meantime the third KVM switch 204c ignores the second identification number of the control signal.

When the first KVM switch 204a is switched from the first video source 226a or the fourth video source 226d to the seventh video source 226g of the third computer 202c, the first KVM switch 204a controls the second KVM switch 204b to select the eighth video source 226h of the third computer 202c in response to the first identification number corresponding to the second KVM switch 204b. Meanwhile, the second KVM switch 204b ignores the first identification number of the control signal. The first KVM switch 204a controls the third KVM switch 204c to select the ninth video source 226i of the third computer 202c in response to the second identification number corresponding to the third KVM switch 204c, and meantime the third KVM switch 204c ignores the second identification number of the control signal.

Since the synchronization cables couple the first KVM switch 204a to the second KVM switch 204b and the third KVM switch 204c sequentially and transmits the control signal to the second KVM switch 204b and the third KVM switch 204c, the first KVM switch 204a can dominate the switch operation of the second KVM switch 204b among the second video source 226b, the fifth video source 226e and the eighth video source 226h, and the switch operation of the third KVM switch 204c among the third video source 226c, the sixth video source 226f and the ninth video source 226i when the first KVM switch 204a is switched among the first video source 226a, the second video source 226b and the third video source 226c. Thus, the first KVM switch 204a and the second KVM switch 204b allow a user to concurrently perform the switch operation at a single time for displaying the images from the video sources (226a through 226b) on the first display 222a and the second display 222b rapidly and conveniently.

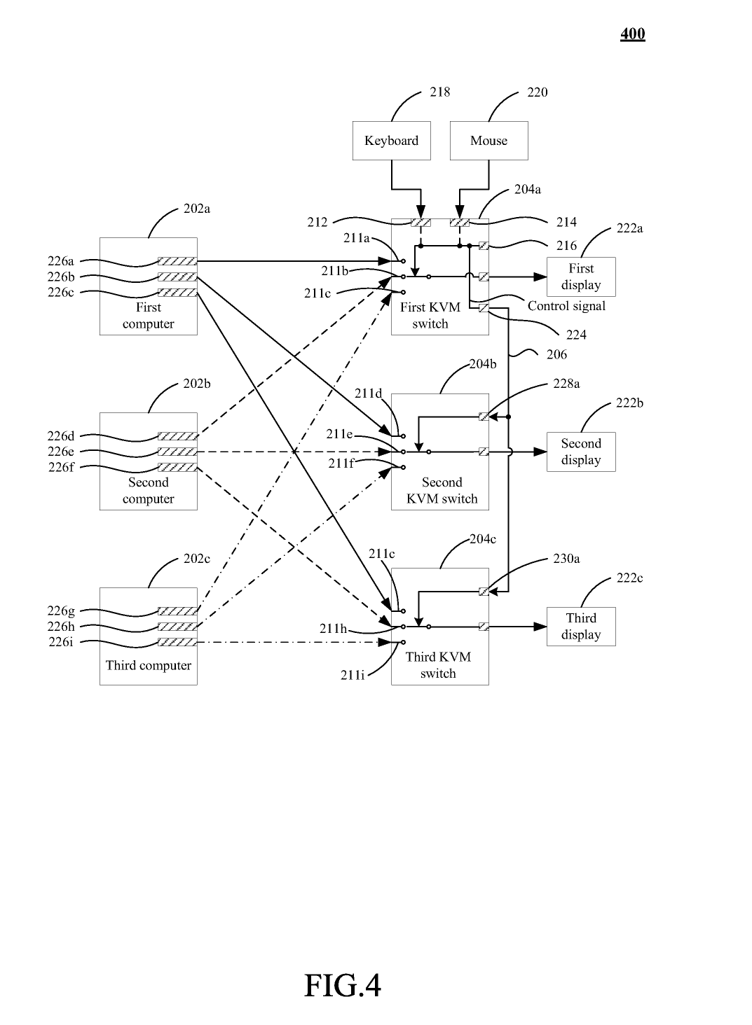

Please refer to FIG. 4 which depicts a schematic diagram of a KVM switch system 400 having a synchronization cable 206 according to the third embodiment of the present invention. The KVM switch system 400 shown in FIG. 4 is similar to the KVM switch system 300 depicted in FIG. 3 except the connection among the first KVM switch 204a, the second KVM switch 204b and the third KVM switch 204c. The differential features shown in FIG. 4 will be depicted in detail below.

The first KVM switch 204a, serving as a master, includes a first control port 224 for outputting the control signal to the second KVM switch 204b. Similarly, the second KVM switch 204b, serving as a slave, includes a second control port 228a. The second control port 228a receives the control signal from the first control port 224 such that the second KVM switch 204b controls the switch operation among the second video source 226b, the fifth video source 226e and the eighth video source 226h and the second control port 228a sends the received control signal to the third KVM switch 204c.

The third KVM switch 204c, also serving as a slave, includes a fourth control port 230a. The fourth control port 230a receives the control signal from the first control port 224 via the synchronization cable 206 such that the third KVM switch 204c controls the switch operation among the third video source 226c, the sixth video source 226f and the ninth video source 226i.

Similar to FIG. 3, the control signal from the first KVM switch 204a also assigns a first identification number and a second identification number to the second KVM switch 204b and the third KVM switch 204c, respectively. When the first KVM switch 204a is switched from the first video source 226a to the fourth video source 226d, the first KVM switch 204a controls the second KVM switch 204b to select the fifth video source 226e in response to the first identification number. Meanwhile, the second KVM switch 204b ignores the first identification number of the control signal. The first KVM switch 204a controls the third KVM switch 204c to select the sixth video source 226f of the second computer 202b in response to the second identification number corresponding to the third KVM switch 204c, and meantime the third KVM switch 204c ignores the second identification number of the control signal. When the first KVM switch 204a is switched from the first video source 226a or the fourth video source 226d to the seventh video source 226g, the first KVM switch 204a controls the second KVM switch 204b to select the eighth video source 226h in response to the first identification number corresponding to the second KVM switch 204b. Meanwhile, the second KVM switch 204b ignores the first identification number of the control signal. The first KVM switch 204a controls the third KVM switch 204c to select the ninth video source 226i of the third computer 202c in response to the second identification number corresponding to the third KVM switch 204c, and the third KVM switch 204c ignores the second identification number of the control signal.

Since the synchronization cable 206 couples the first KVM switch 204a to the second KVM switch 204b and the third KVM switch 204c, respectively, and transmits the control signal to the second KVM switch 204b and the third KVM switch 204c, the first KVM switch 204a can dominate the switch operation of the second KVM switch 204b among the second video source 226b, the fifth video source 226e and the eighth video source 226h, and the switch operation of the third KVM switch 204c among the third video source 226c, the sixth video source 226f and the ninth video source 226i when the first KVM switch 204a is switched among the first video source 226a, the fourth video source 226d and the seventh video source 226g. Thus, the first KVM switch 204a and the second KVM switch 204b allows a user to concurrently perform the switch operation at a single time for displaying the images from the video sources (226a through 226i) on the first display 222a and the second display 222b rapidly and conveniently.

In FIG. 3 and FIG. 4, it should be noted that console devices, including the keyboard 218 and the mouse 220, are selectively connected to one of the first KVM switch 204a, the second KVM switch 204b or the third KVM switch 204c to simplify the switch operation. In the present invention, the keyboard 218 and the mouse 220 are only connected to the first KVM switch 204a but not connected to the second KVM switch 204b or the third KVM switch 204c. Additionally, when one of the keyboard 218 and the mouse 220 is connected to the first KVM switch 204a, the KVM switch system 300 can advantageously implements the switch action among the first computer 202a, the second computer 202b and the third computer 202c once.

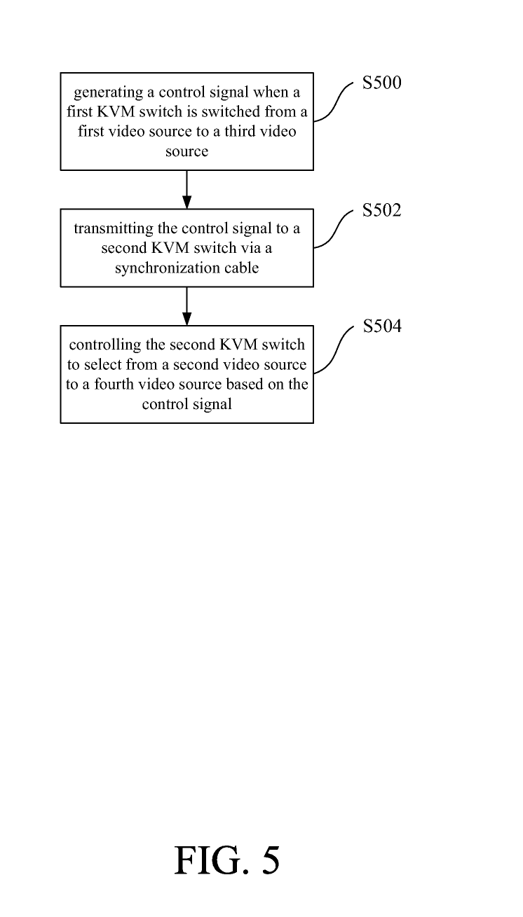

Please refer to FIG. 2 and FIG. 5 depicting a flow chart of performing the KVM switch system 200 according to one embodiment of the present invention. As depicted in the above-mentioned description, the KVM switch system 200 enables a first KVM switch 204a and a second KVM switch 204b to switch between a first computer 202a and a second computer 202b synchronously via a synchronization cable 206. The method of controlling the KVM switch system 200 is implemented on the basis of the steps depicted in FIG. 5. First, in step S500, the first KVM switch 204a generates a control signal when the first KVM switch 204a is switched from a first video source 208a of a first computer 202a to a third video source 208c of a second computer 202b. Afterwards, in step S502, the control signal of the first KVM switch 204a is transmitted to the second KVM switch 204b via the synchronization cable 206. In one embodiment, while the first KVM switch 204a is switched to a third video source 208c from the second computer 202b, the control signal is transmitted by the first KVM switch 204a and outputted to the second KVM switch 204b. The control signal is sent by a cable of transmitting an audio signal. Finally, in step S504, the second KVM switch 204b is controlled by the first KVM switch 204a to select from a second video source 208b of the first computer 202a to a fourth video source 208d of the second computer 202b, without manual operation, in response to the control signal.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A KVM switch system for switching between a first computer and a second computer, wherein the first computer provides a first video source and a second video source, and the second computer provides a third video source and a fourth video source, the KVM switch system comprising:
a first KVM switch having a first video port and a second video port, switching the first video source and the third video source therebetween, wherein the first video port and the second video port can be coupled to the first video source of the first computer and the third video source of the second computer, respectively;
a second KVM switch having a third video port and a fourth video port, switching the second video source and the fourth video source therebetween, wherein the third video port and the fourth video port can be coupled to the second video source of the first computer and the fourth video source of the second computer, respectively; and
a synchronization cable coupling the first KVM switch to the second KVM switch, transmitting a control signal to the second KVM switch;
wherein when the first KVM switch is switched from the first video source to the third video source, the first KVM switch controls the second KVM switch to select the fourth video source of the second computer in response to the control signal transmitted by the synchronization cable.

2. The KVM switch system according to claim 1, wherein the first KVM switch or the second KVM switch comprises one set of console port.

3. The KVM switch system according to claim 1, wherein the synchronization cable is a cable of transmitting an audio signal.

4. The KVM switch system according to claim 1, wherein the synchronization cable is a pair of conducting wires for transmitting the control signal.

5. The KVM switch system according to claim 1, wherein the first KVM switch further comprises a first control port for outputting the control signal to the second KVM switch.

6. The KVM switch system according to claim 5, wherein the second KVM switch further comprises a second control port coupling the first control port of the first KVM switch to the second KVM switch via the synchronization cable for transmitting the control signal.

7. A KVM switch system for switching between a first computer and a second computer, wherein the first computer provides a first video source and a second video source, the second computer provides a third video source and a fourth video source, the KVM switch system comprising:
a master KVM switch having a first video port and a second video port, switching the first video source and the third video source therebetween, wherein the first video port and the second video port can be coupled to the first video source of the first computer and the third video source of the second computer, respectively; and
a synchronization cable coupling the master KVM switch to a slave KVM switch, transmitting a control signal to the slave KVM switch;
wherein when the master KVM switch is switched from the first video source to the third video source, the master KVM switch controls the slave KVM switch to switch from the second video source to the fourth video source of the second computer in response to the control signal transmitted by the synchronization cable.

8. The KVM switch system according to claim 7, wherein the synchronization cable is a cable of transmitting an audio signal.

9. The KVM switch system according to claim 7, wherein the synchronization cable is a pair of conducting wires for transmitting the control signal.

10. The KVM switch system according to claim 7, wherein the master KVM switch further comprises a first control port for outputting the control signal to the slave KVM switch.

11. A KVM switch system for switching between a first computer, a second computer and a third computer, wherein the first computer provides a first video source, a second video source and a third video source, the second computer provides a fourth video source, a fifth video source and a sixth video source, and the third computer provides a seventh, an eighth video source and a ninth video source, the KVM switch system comprising:
a first KVM switch having a first video port, a second video port and a third video port, wherein the first video port, the second video port and the third video port can be coupled to the first video source, the fourth video source and the seventh video source, respectively;
a second KVM switch having a fourth video port, a fifth video port and a sixth video port, wherein the fourth video port, the fifth video port and the sixth video port can be coupled to the second video source, the fifth video source and the eighth video source, respectively;
a third KVM switch having a seventh video port, a eighth video port and a ninth video port, wherein the seventh video port, the eighth video port and the ninth video port can be coupled to the third video source, the sixth video source and the ninth video source, respectively; and
a synchronization cable coupling the first KVM switch to the second KVM switch and the third KVM switch, transmitting a control signal to the second KVM switch and the third KVM switch;
wherein when the first KVM switch is switched, the first KVM switch controls the switch statuses of the second KVM switch and the third KVM switch in response to the control signal transmitted by the synchronization cable.

12. The KVM switch system according to claim 11, wherein the control signal from the first KVM switch further assigns a first identification number and a second identification number to the second KVM switch and the third KVM switch, respectively.

13. The KVM switch system according to claim 12, wherein when the first KVM switch is switched from the first video source to the fourth video source of the second computer, the first KVM switch controls the second KVM switch to select the fifth video source of the second computer in response to the first identification number corresponding to the second KVM switch, and the first KVM switch controls the third KVM switch to select the sixth video source of the second computer in response to the second identification number corresponding to the third KVM switch.

14. The KVM switch system according to claim 12, wherein when the first KVM switch is switched from the first video source or the fourth video source to the seventh video source of the third computer, the first KVM switch controls the second KVM switch to select the eighth video source of the third computer in response to the first identification number corresponding to the second KVM switch, and the first KVM switch controls the third KVM switch to select the ninth video source of the third computer in response to the second identification number corresponding to the third KVM switch.

15. The KVM switch system according to claim 11, wherein the first KVM switch, the second KVM switch or the third KVM switch comprise one set of console port.

16. The KVM switch system according to claim 11, wherein the synchronization cable is a cable for transmitting an audio signal.

17. The KVM switch system according to claim 11, wherein the synchronization cable is a pair of conducting wires for transmitting the control signal.

18. The KVM switch system according to claim 11, wherein the first KVM switch further comprises a first control port for outputting the control signal to the second KVM switch and the third KVM switch.

19. The KVM switch system according to claim 18, wherein the second KVM switch further comprises a second control port and a third control port, and the second control port receives the control signal from the first control port and sends the received control signal to the third KVM switch via the third control port for controlling the switch operation among the second video source, the fifth video source and the eighth video source.

20. The KVM switch system according to claim 19, wherein the third KVM switch further comprises a fourth control port, and the fourth control port receives the control signal from the third control port for controlling the switch operation among the third video source, the sixth video source and the ninth video source.

21. The KVM switch system according to claim 18, wherein the second KVM switch further comprises a second control port, the second control port receives the control signal from the first control port and sends the received control signal to the third KVM switch for controlling the switch operation among the second video source, the fifth video source and the eighth video source.

22. The KVM switch system according to claim 21, wherein the third KVM switch further comprises a fourth control port, and the fourth control port receives the control signal from the first control port for controlling the switch operation among the third video source, the sixth video source and the ninth video source.

23. A method of controlling a first KVM switch and a second KVM switch to switch between a first computer and a second computer, wherein the first computer provides a first video source and a second video source, the second computer provides a third video source and a fourth video source, wherein the first KVM switch can be coupled to the first video source or the third video source, and the second KVM switch can be coupled to the second video source or the fourth video source, the method comprising the steps of:
generating a control signal when the first KVM switch is switched to the third video source from the first video source;
transmitting the control signal to the second KVM switch; and
controlling the second KVM switch to select the fourth video source of the second computer based on the control signal.

24. The method according to claim 23, wherein while the first KVM switch is switched to a third video source from the second computer, the control signal is transmitted to the second KVM switch without manual operation.
